(19) United States
(12) Patent Application Publication
(10) Pub. No.: US 2018/0214787 A1
(43) Pub. Date: Aug. 2, 2018

(54) TOY INTERACTIVE ENTERTAINMENT DEVICES

(71) Applicant: Cepia LLC, St. Louis, MO (US)

(72) Inventors: James Russell Hornsby, Winter Park, FL (US); Joseph Lee McGowan, St. Charles, MO (US); Christian Mathis Mouser, Ballwin, MO (US); Genevieve Lark Wood, St. Peters, MO (US)

(21) Appl. No.: 15/797,139

(22) Filed: Oct. 30, 2017

Related U.S. Application Data
(60) Provisional application No. 62/453,723, filed on Feb. 2, 2017.
(60) Provisional application No. 62/501,967, filed on May 5, 2017.
(60) Provisional application No. 62/509,085, filed on May 20, 2017.

(51) Int. Cl. A63H 33/22; A63J 21/00; A63H 5/00; A63H 33/26

(52) U.S. Cl. CPC A63H 33/22; A63J 21/00; H04B 10/502; A63H 33/26; A63H 5/00

(57) ABSTRACT

Interactive entertainment devices including a toy magic wand with integrated electronics for, among other things, detecting wand motion and responding accordingly, such as illuminating one or more LEDs, displaying images on one or more LCD displays, playing sound effects or character speech, emitting infrared (IR) signals via one or more IR emitters, or some combination thereof. An exemplary device may include a “fairy house” or “wizard tower” playset with integrated electronics for receiving one or more received IR signals and responding or reacting accordingly. For example, depending on the nature of the received IR signals, the electronics may illuminate one or more LEDs, display images on one or more LCD displays, play sound effects or character speech, emit IR signals via one or more IR emitters, or some combination thereof.

### CROSS-REFERENCE TO RELATED APPLICATIONS

This application claims the benefit of U.S. Provisional Application 62/453,723, filed Feb. 2, 2017, U.S. Provisional Application 62/501,967, filed May 5, 2017, and U.S. Provisional Application 62/509,085, filed May 20, 2017.

### BACKGROUND

At present, toy wands and accompanying accessories lack coordinated action and/or activities. Aspects of the present invention advantageously provide, among other things, a coordinated audiovisual and auditory experience to a person using a wand and/or accompany. g accessories that embody one or more aspects of the present invention.

### BRIEF SUMMARY OF THE INVENTION

The following presents a simplified summary in order to provide a basic understanding of some aspects of the invention. This summary is not an extensive overview. It is not ended to identify key or critical elements of the invention or to delineate the scope of the invention. The following summary merely presents some concepts of the invention in a simplified form as a prelude to the more detailed description provided below.

Aspects of the present invention relate to interactive entertainment devices. According to aspects of the present invention, an exemplary device may include a toy magic wand with integrated electronics for, among other things, detecting wand motion and responding accordingly, such as illuminating one or more LEDs, displaying images on one or more LCD displays, playing sound effects or character speech, emitting infrared (IR) signals via one or more IR emitters, or some combination thereof. In some embodiments, one or more toy magic wand may include an “apprentice”-type wand that generally includes a subset of features of the exemplary toy magic wands described herein.

According to aspects of the present invention, an exemplary device may include a “fairy house” or “wizard tower” playset with integrated electronics for receiving one or more received IR signals and responding or reacting accordingly. For example, depending on the nature of the received IR signals, the electronics may illuminate one or more LEDs, display images on one or more LCD displays, play sound effects or character speech, emit IR signals via one or more IR emitters, or some combination thereof.

According to aspects of the present invention, an integrated interactive entertainment device may include, among other things, a wand, with the wand being generally cylindrical about a first axis. The wand may have a first end and a second end, with the wand having a base portion extending from the first end toward the second end, configured to be held in a hand of a user, wherein a length of the base portion widens perpendicularly with respect to the first axis into a middle portion. The wand may have a stem section extending from the middle portion towards the second end, wherein the base section, middle portion, and stem section each contain a cavity therein, with the cavity generally extending along a length of said first axis. The device may further include one or more light sources, with light sources positioned at the second end, a first display device, with the first display device positioned a:t said middle portion and oriented such that the first display device is viewableby the user, and a second display device, with the second display device positioned within the cavity of said stem portion, one or more orientation devices, and one or more electronic devices, with the electronic devices being operatively connected to the first display device, the second display device, the orientation devices, and the light sources. According to aspects of the present invention, the electronics are configured to selectively execute one or more instructions based on information received from the orientation devices, with the instructions enabling a coordinated displaying of images on the first and second display devices and driving the light sources.

According to aspects of the present invention, an integrated interactive entertainment device may include, among other things, a wand, with the wand being generally cylindrical about a first axis, with the wand having a first end and a second end. The wand may further have a base portion extending from the first end toward the second end, configured to be held in a hand of a user, wherein a length of the base portion widens perpendicularly with respect to the first axis into a middle portion,with the wand having a stem section extending from the middle portion towards the second end, wherein said base section, middle portion, and stem section each contain a cavity therein, said cavity generally extending along a length of said first axis. The entertainment device may additionally include a display device, with the display device being positioned within the cavity of said stem portion, one or more motion-detection devices, and one or more electronic devices, with the electronic devices operatively connected to the display device, and the one or more motion-detection devices, wherein the electronics are configured to selectively execute one or more instructions based on information received from the one or more motion-detection devices, with the instructions enabling a displaying of images on the display device.

### BRIEF DESCRIPTION OF THE DRAWINGS

FIGS. 1A-1E illustrate exemplary toy wands, according to various aspects described herein.

FIG. 2A illustrates an exemplary diagram illustrating exemplary steps for determining various states of an interactive device and executing appropriate functionality,

FIG. 2B illustrates an exemplary spell storyboard, and FIG. 2C illustrates an exemplary quest storyboard, according to various aspects described herein.

FIG. 3 illustrates exemplary spell combination/codes corresponding to one or more motions or movements of an exemplary interactive device, according to various aspects described herein.

FIGS. 4A-4C illustrate exemplary accessory devices and their corresponding elements, structures, and features, FIG. 4D illustrates an exemplary flowchart corresponding to the operation of the exemplary accessory devices, and FIG. 4E illustrates an exemplary accessory device and its corresponding elements, structures, and features, each according to various aspects as described herein.

FIGS. 5-6 illustrate exemplary toy wands, e.g., “apprentice” wands, according to various aspects described herein.

FIGS. 7A-7F illustrate exemplary displays corresponding to one or more spell animations displayed on one or more display devices of an exemplary toy wand, according to various aspects described herein.

FIG. 8 is a block diagram illustrating an example of a suitable computing system environment in which aspects of the invention may be implemented.

### DETAILED DESCRIPTION

In the following description of the various embodiments, reference is made to the accompanying drawings, which form a part hereof, and in which is shown by way of illustration various embodiments in which features may be practiced. It is to be understood that other embodiments may be utilized and structural and functional modifications may be made.

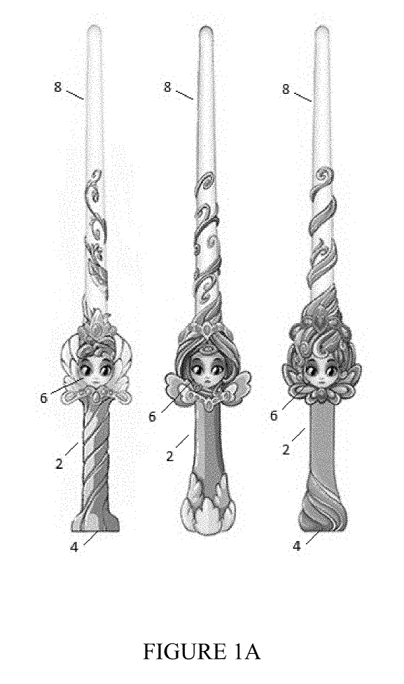

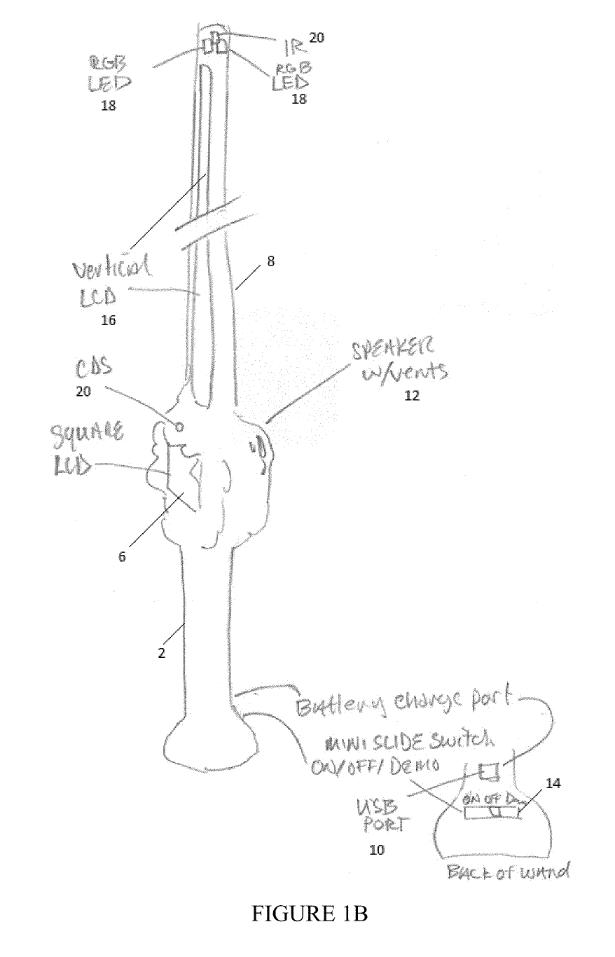

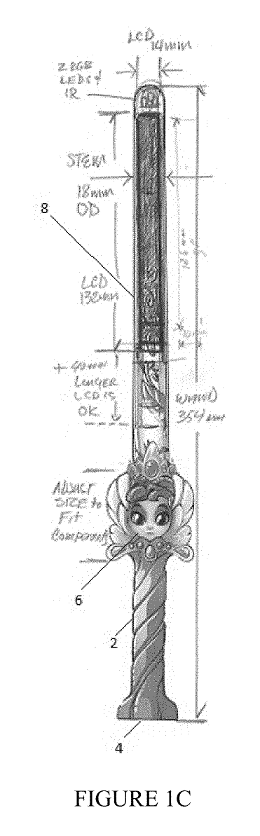

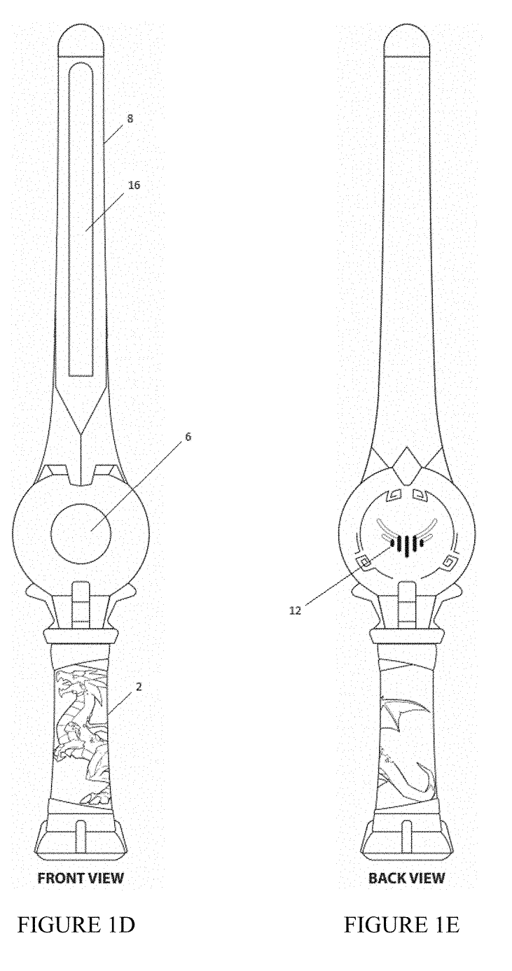

As noted above, aspects of the present invention include interactive entertainment devices such as a toy magic wand. Exemplary wands are illustrated in FIGS. 1A-1C. In these examples, various ornamental features are demonstrated that give the toy an appearance of a wand. In the example of FIGS. 1A-1C, the handle (alternately, the “base”) 2 may include features such as spiral-shaped grooves or raised portions of the handle material, one or more “leaf”-shaped elements, or other appropriate elements, or some combination thereof In these examples, the bottom surface 4 of the wand is flat, so that the wand may stand vertically as shown. Significantly, a cavity is contained within the base, within which one or more electrical/electronic elements may be placed or otherwise located for performing or otherwise effectuating the functionality described herein, e.g., powering LEDs on and off, driving LCD displays, receiving motion or light level information, etc. As illustrated, the base continues upward to a wider section.

As illustrated in FIGS. 1A-1C, the toy wand structure widens near the top end of the base. According to aspects of the present invention, the widened-portion of the toy wand includes one or more framing elements for one or more LCD displays 6 positioned within the portion. While LCD displays 6 are generally described throughout, any suitable display device or devices may be utilized without departing from the scope of the present invention. For example, the exemplary wands in FIGS. 1A and 1C illustrate an exemplary image of a “fairy face” being displayed via the enclosed LCD display 6. Other images or animations, however, may be displayed during the operation of the toy wand.

As further illustrated in FIGS. 1A-1C, the wand structure continues upward from the widened section and extends to a rounded, distal end. This “wand stem” 8 may include a cavity within its structure, with this cavity generally extending from the widened section towards the distal end. According to aspects of the present invention, while FIG. 1C illustrates an exemplary wand measuring 354 mm, other wand lengths may be utilized without departing from the scope of the present invention. Furthermore, one or more elements may be placed at or near the distal end, including ornamental features such as a star-shaped feature, operative elements such as LEDs or IR emitters, or some combination thereof.

In order to better describe the various aspects of the present invention, an exemplary toy magic wand is described herein for illustrative purposes only and should not be construed as limiting aspects of the invention. In an exemplary embodiment of the toy wand (FIGS. 1B-1C), an approximately 14-inch long wand is illustrated, with elements for lights, sounds, and animations displayed on color LCD screens 6. The exemplary wand may be configured with the visual characteristics, elements, features, etc., shown in FIG. 1A, or may be configured in a similar or different manner, e.g., pixie wands, wizard wands, enchanted swords, scepters, etc. In other words, each of these is an exemplary type of an interactive entertainment device within the scope of the present invention. Generally speaking, the visual characteristics of the interactive entertainment device is indicative of the “personality” profile of the device, e.g., three different pixies as demonstrated in FIG. 1A, as further described below.

As illustrated in FIGS. 1B-1C, an exemplary wand may include one or more electronic elements, components, structures, etc., for operating or effectuating the features of the wand (generally not shown, as being contained and/or positioned within the wand). For example, the wand may include one or more integrated controllers (“IC”), microcontrollers, microprocessors, or other appropriate controllers. For the sake of clarity, such controllers will be generally referred to as ICs, unless otherwise noted. An exemplary wand may additionally include one or more motion/orientation-sensitive elements, such as an accelerometer, which provides information accessible to the IC for detecting, registering, or otherwise determining a forward/backward movement of the wand, a side-to-side movement of the wand, an upside-down position of the wand, or any other appropriate movement or orientation of the wand, or some combination thereof. An exemplary wand may further include one or more light-sensitive elements or sensors (e.g., CDS photo-cell sensor 20). An exemplary wand may additionally include one or more microphones for capturing auditory information for use during operation of the wand, e.g. responding to voice commands (“dance to the music”), activating functionality in response to music, etc.

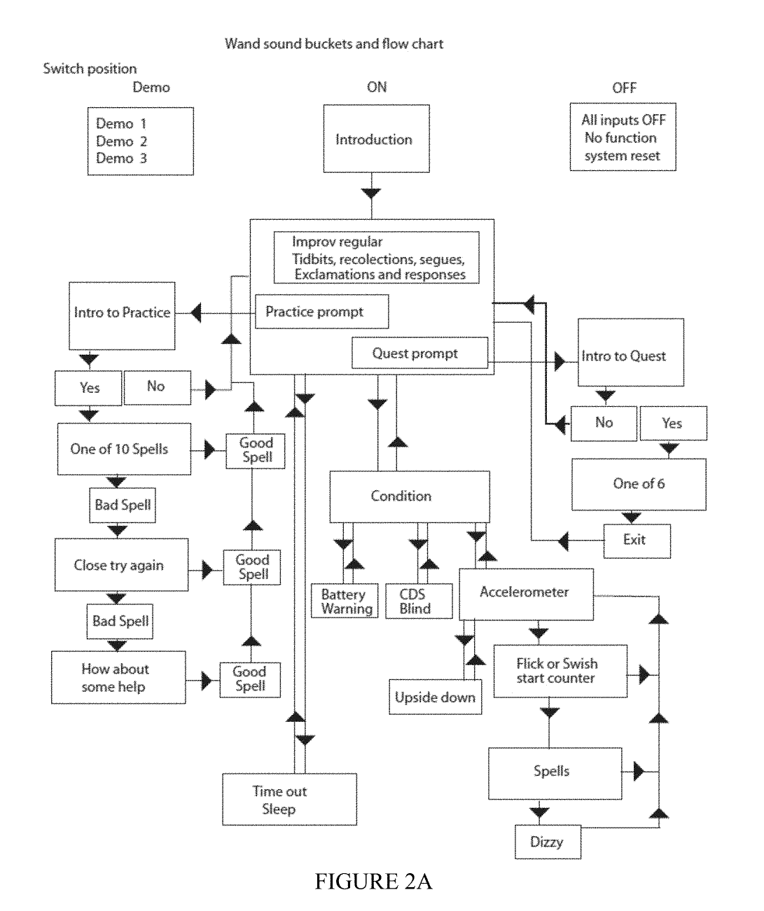

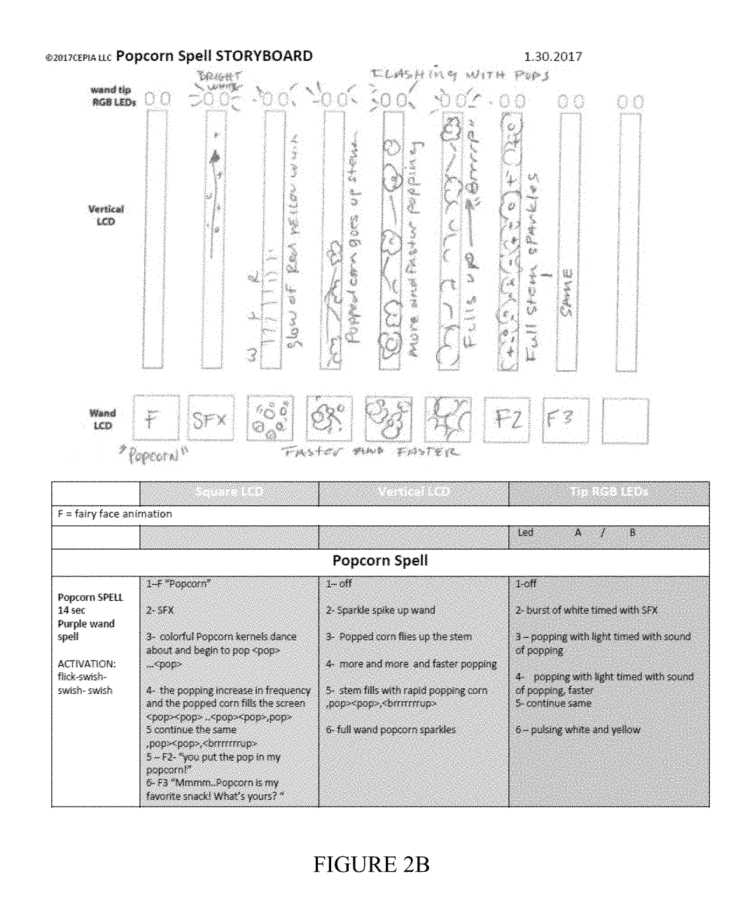

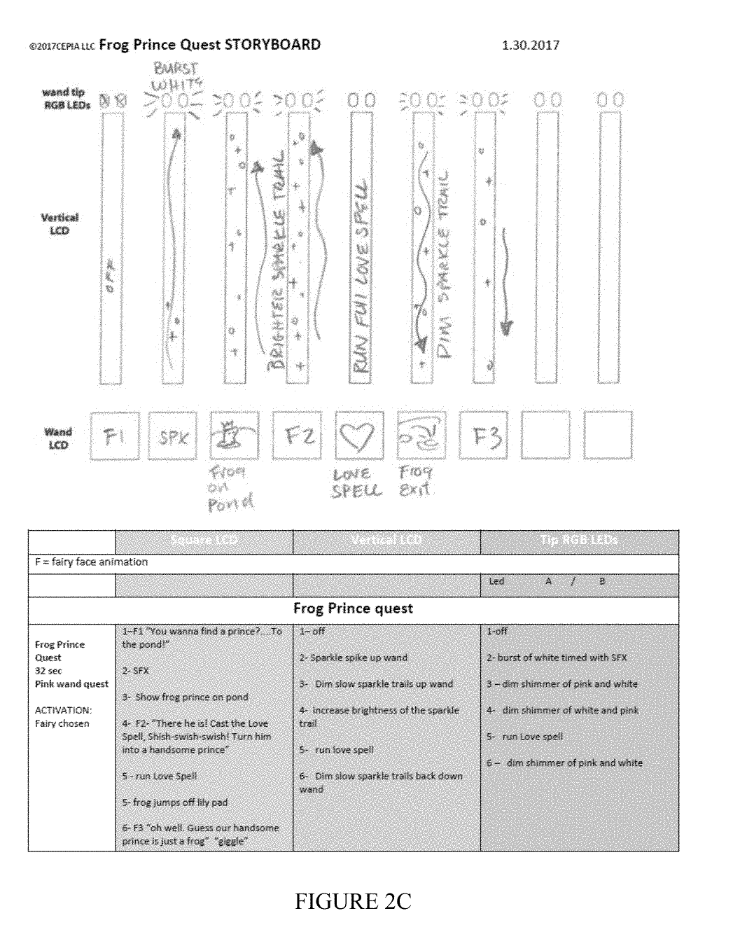

The exemplary toy wand may further include, within its structure, one or more power sources for the electrical/electronic elements of the wand. For example, an exemplary power sources may include standard battery cells, proprietary battery cells, or some combination thereof. These power sources may be single-use or recharge, and may be user-replaceable or non-replaceable. According to aspects of the present invention, an exemplary wand may include an externally-oriented port for power source charging, such as a USB port 10. The port 10 may optionally enable programming/instruction updates for the wand, e.g., updates to the functions/instructions implementing the functionality shown in the exemplary flowchart of FIG. 2A, adding new functionality, removing functionality, etc. The IC may signal a low battery warning and/or battery charge level via an appropriate indicator, e.g., visual elements on one or more of the LCD displays 6, sounds played over one or more speakers 12, etc. In some embodiments, an exemplary wand may not operate when the batteries are being charged and the LCD display 6 may show a battery status indicator or icon. As illustrated in FIG. 1B, an exemplary wand may additionally include an “ON/OFF” or an “ON/OFF/DEMO” switch 14.

The exemplary toy wand further includes a vertically-oriented LCD display device 16 positioned within the upper end of the wand (alternately, the “stem”) 8, and includes LEDs 18 at or near the distal end of the stem. The exemplary wand in FIGS. 1B-1C demonstrate two RGB LEDs 18 in proximity to an IR-emitting element 20. In some embodiments, the RGB LEDs 18 may project a bright spot light focused approximately 8-10 meters from the distal end of the stem 8. In this example, the stem 8 is comprised of a translucent or transparent material. In some embodiments, the stem includes a protective lens covering the vertically-oriented LCD display device. According to aspects of the present invention, the protective lens may additionally magnify, enlarge, enhance, or alter the visual image on the LCD screen, or some combination thereof. Significantly, the ICs will drive the LCD displays 6, RGB LEDs 18 (together or independently), and/or IR emitters 20 in response to the information it received regarding the orientation, movement, and other pertinent information regarding the wand, as defined or otherwise determined by one or more instructions that makes up the wand's personality profile, e.g., spell scripts comprised of one or more movements or motions of the distal end of the stem 8.

In operation, an IR emitter 20 at or near the distal end of the stem 8 emits an IR signal each time a user makes a “flick” (e.g., forward-backward motion) or “swish” (e.g., side-to-side motion) with the wand, based on movement/position information determined by the ICs. For the purposes of this example, the exemplary wand may be in one of two exemplary states—an “Explore” mode and a “Quest” mode“. The Explore mode may further include an “Improv” mode (which permits a user to move the wand about and the ICs will generally drive the LEDs 18, LCD screens 6, speaker 12, etc., without regard to the type or pattern of the movement) and a “Practice” mode, wherein the user is prompted to perform one or more of the spell scripts and, based on the combination of motions/movements performed and the motions/movements defined by the script, the ICs activate or drive the appropriate visual, auditory, etc., elements to indicate success or failure. In the “Quest” mode, the ICs may drive the IR emitter 20 when a particular spell is cast. In some embodiments, an exemplary wand may also have a “Dance” interaction mode, wherein one or more microphones may be activated and when music is detected via the microphones, a fairy may be shown on the LCD 6 and animated to dance with the detected music (e.g., animated only while music is detected, animated for a set period of time when music is detected, etc.), or other appropriate functionality may be performed. Advantageously, one or more elements of an exemplary wand may be utilized to determine various states that the wand may be in or otherwise experiencing, which results in appropriate functionality being performed—for example, when upside down (e.g., based on accelerometer information), one or more appropriate animations, sounds, speech, etc. may be performed that reflect the state, e.g., a voice indicating “I don't like being upside down”. Other states may include, but are not limited to, a “shaken until dizzy” state (e.g., based on accelerometer information), a “fairy's eyes are covered” state (e.g., based on CDS sensor 20 information), a “battery charge level low” state, or a “timed off' state such as when the wand is not being used (e.g., based on accelerometer information, CDS sensor 20 information, etc.). While not listed, additional states may be available and are clearly within the scope of the present invention. FIGS. 1D and 1E illustrate additional exemplary embodiments, according to aspects of the present invention.

Generally speaking, spells are cast when a specific set or combinations of flicks or swishes are made by the user using the wand. If the ICs determine there is wand motion, the ICs may count a particular motion and wait for the next motion to determine the proper action, e.g., which spell, if any, matches the motions. For example, a flick followed by an additional flick and a swish may comprise a defined spell, indicated that the ICs should play appropriate animations on the LCD screens, light up the RGB LEDs, and play an appropriate sound file (such as sound effects and/or character speech). Each spell defined by a spell script may indicate a unique set of animations, sounds effects/character speech, LED light display, or some combination thereof, associated with that spell.

In other words, one of the purposes of the wand is to give the user an audiovisual experience of discovering magic by actually casting a spell. In order to accomplish this, the wand may detect (through its various sensors) that a user has performed a particular wand movement/motion or series of motions for which an audiovisual display should be provided to the user. For example, if the user performs a series of actions/motions that indicate a “Firefly” spell, an exemplary audiovisual display may create an experience whereby the user believes the fairy living in the wand calls out the “magic” as it is displayed on the LCD 6 near the handle 2 of the wand, such as colored orbs or dots floating around the screen. The user should then see the magic “rise up” from the base 2 into the stem of the wand, flow from the base, up through the stem 8 towards the wand tip, and once the magic has reached the tip, the LEDs 18 flash or otherwise light up so that the user believes the magic to have left the wand. By utilizing imagery and animation shown on the multiple LCD displays 6 and 16 positioned throughout the wand, in coordination with playing sounds effects through a speaker 12 and lighting the LEDs 18 on the wand tip, the user is provided the experience of performing magic. And by coordinating this audiovisual sequence with the emission of appropriate IR signals via IR emitter 20, as described throughout, the user is given the experience of affecting other objects because of performing the magic or spell, as explained further below (e.g., Pixie Jump Spells and accessory devices).

According to aspects of the present invention, one or more exemplary accessory devices may be utilized in conjunction with an exemplary wand, wherein the exemplary accessory devices are configured to detect or receive an IR signal emitted from one or more exemplary wands. For example, the IR signal emitted from an exemplary wand via an IR emitter 20 may be sent for a certain period of time in order to trigger one or more accessories, e.g., 3-second time period. The exemplary accessory may be configured to detect a set of IR signals from one or more exemplary wands, e.g., code #1 may be common to all wands and accessories, code #2 may be a “Pink Pixie” wand code, code #3 may be a “Blue Pixie” wand code, code #4 may be a “Purple Pixie” wand code. For example, the IR signal that is emitted by an exemplary wand is coded to identify the wand it was sent from—a pink wand sends a code for a pink Pixie, a blue wand sends a code for a blue Pixie, and a purple wand sends a code for a purple Pixie, e.g., the exemplary wands illustrated in FIGS. 1A-1C.

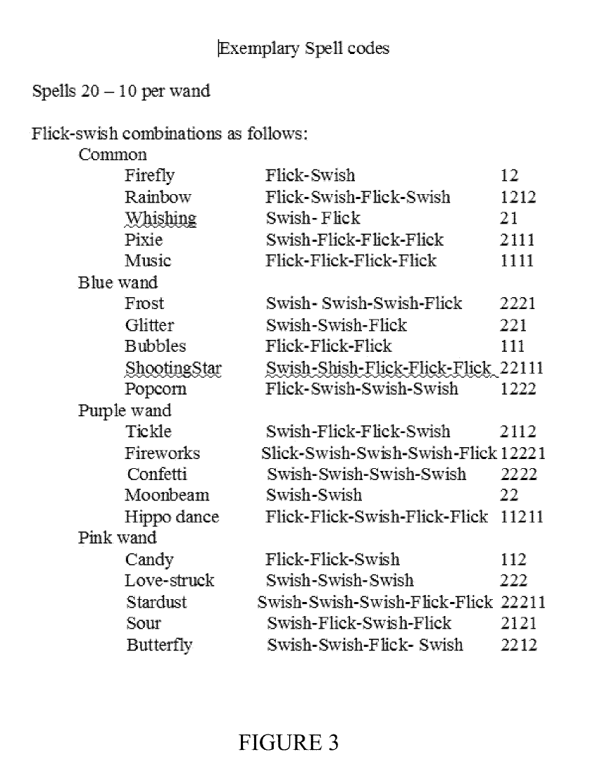

According to aspects of the present invention, a user of an exemplary wand may be able to perform a number of spells with each wand, some being common across a set of exemplary wands, while others may be specific to the exemplary personality profile of the wand. An exemplary set of spells and the movements/motions associated with each spell are demonstrated in FIG. 3. For example, an exemplary wand may have twelve different spells it may perform—in this example, four of the spells may be unique to the personality profile of the wand, which are generally not available on other exemplary wands with different personality profiles. In some embodiments, one or more of the spells available on the exemplary wand may be “hidden” and utilized during quests/adventures, wherein each exemplary wand may have one or more quests/adventures and some number of those quests/adventures may be unique to the personality profile of the wand. It should be understood that these exemplary spells and associated motions are merely illustrative and other combinations are clearly within the scope of the present invention, e.g., those described in accompanying Exhibits 1A, 1B, 2A, and 2B.

According to aspects of the present invention, an exemplary play sequence may proceed as follows, depending upon the relative position of the exemplary wand's “ON/OFF/DEMO” switch. In DEMO mode (generally used by retailers displaying the product), removal of a pull tab (not shown in the FIGURES) activates the CDS light sensor 20. When the CDS sensor 20 detects a light in light, such as the shadow of a passerby, the ICs execute a “demo script”, which defines the appropriate sounds, speech, animations, lights to play to demonstrate the functionality of the particular wand. The “demo script” may execute, reset, and then wait for the next CDS sensor 20 trigger. This demo mode executes or otherwise performs similar functionality on related accessories.

In ON mode, the process may proceed as follows:
1) ON—wand lights up (e.g., LED script 1) and plays a magic bling sound (e.g., sound script 1).
2) An intro video plays on the LCD screens (e.g., Intro videol)
3) Wand goes to Explore mode
4) In Explore mode, every time the wand is flicked or swished a LED light script and a sound script plays (e.g., Script 2) and the IR signal is sent.
5) In Explore mode, there are two basic play patterns, Improvisation (Improv) and Practice.
6) During Improv, the wand animates and plays sounds during wand motion.
7) After every 7^{th} Improv motion (or some other fixed number of motions or fixed amount of time), script will ask if user wants to practice casting spells, wants to go on a quest/adventure, or wants to Dance. For example, a flick with respect to the option may indicate YES, a Swish (or no action) may indicate NO
8) If NO, return to Improv script
9) If YES to practice casting spells, go to Practice SPELLS scripts
10) The wand will select one of the Spells available to practice or one of the Quick Magic Play scripts and play that script. When the Spell is completed correctly or the Quick Play is completed, the wand returns to Improv scripts
11) If YES to go on a quest/adventure, go to Quick Quest Scripts.
12) The wand will select one of the available quests/adventures and step the user through it. During the selected quest, the user may discover or unlock hidden spells that were not previously available to the user. When completed, the wand returns to Improv scripts.
13) If YES to Dance, the wand will activate the microphone and listen for outside music/noise input from 60 seconds. If music/noise is detected, a dancing fairy animation is activated and displayed on one or more of the LCD screens. After the animation completes, the wand returns to Explore mode.
14) During Explore mode (in either Improv or Practice), idle time puts the wand into sleep mode TIME OUT to save or converse battery power.
15) In Explore mode, any FLICK of the wand triggers 2 seconds of IR. The IR signal may be picked up by an accessory in the room if the accessory is turned on, exemplary accessories are further described below, e.g., House play set, a magic Tea Cup. For example, the Tea Cup may light up and reveal its face and play a sound the first time the wand's IR signal is detected. The second time, it may light up, play a sound script and spin, etc.
16) The accessories may respond to the common IR signal as well as the Pixie coded IR signals. The Time Out period is 2 minutes of idle or no movement input (or other appropriate time limits). The wand may prompt the user every 15 seconds with an idle script until either a movement is detected or the wand falls asleep.

Furthermore, the exemplary flowchart shown in FIG. 2A generally illustrates this process, as well as illustrates other exemplary functionality. FIG. 2B illustrates an exemplary storyboard regarding the functionality executed in response to the successful completion of a particular spell. FIG. 2C illustrates an exemplary storyboard regarding the functionality executed during a quest. With respect to the Sleep state described above, the ON/OFF/DEMO switch 14 and/or information received from the accelerometers may be utilized to transition the exemplary wand out of the Sleep state. In some embodiments of the present invention, the OFF position of the switch may be utilized as a reset on the control IC. In the exemplary Sleep mode described above, the CDS 20 sensor may be inactive.

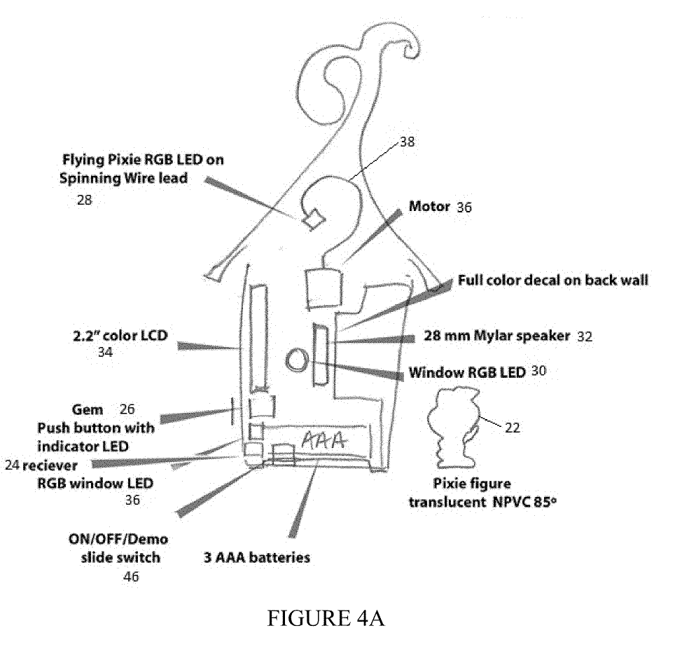

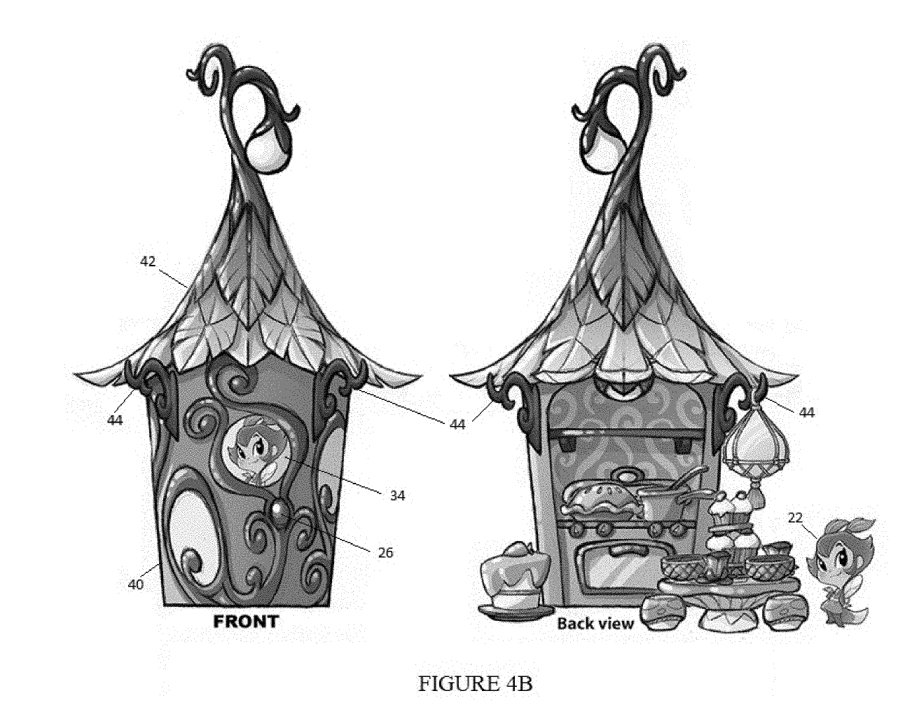

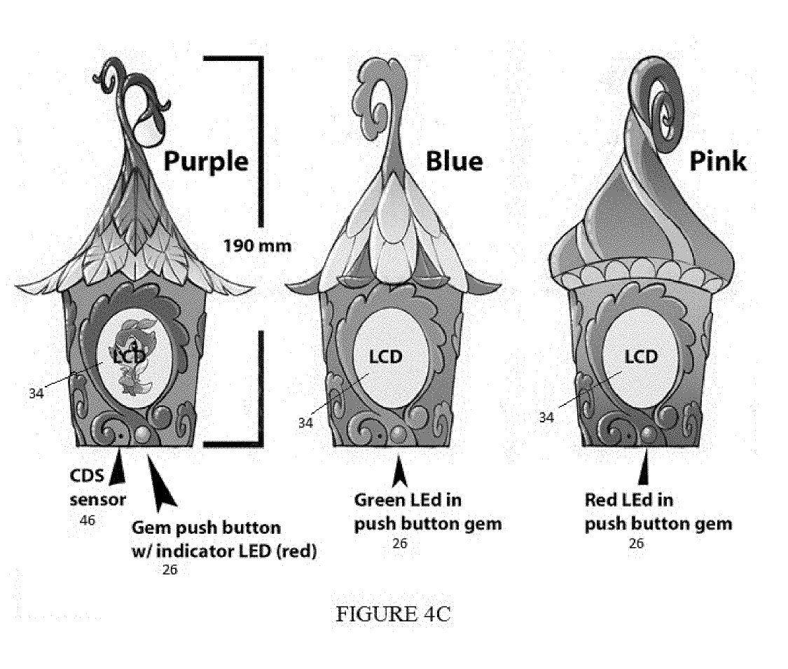

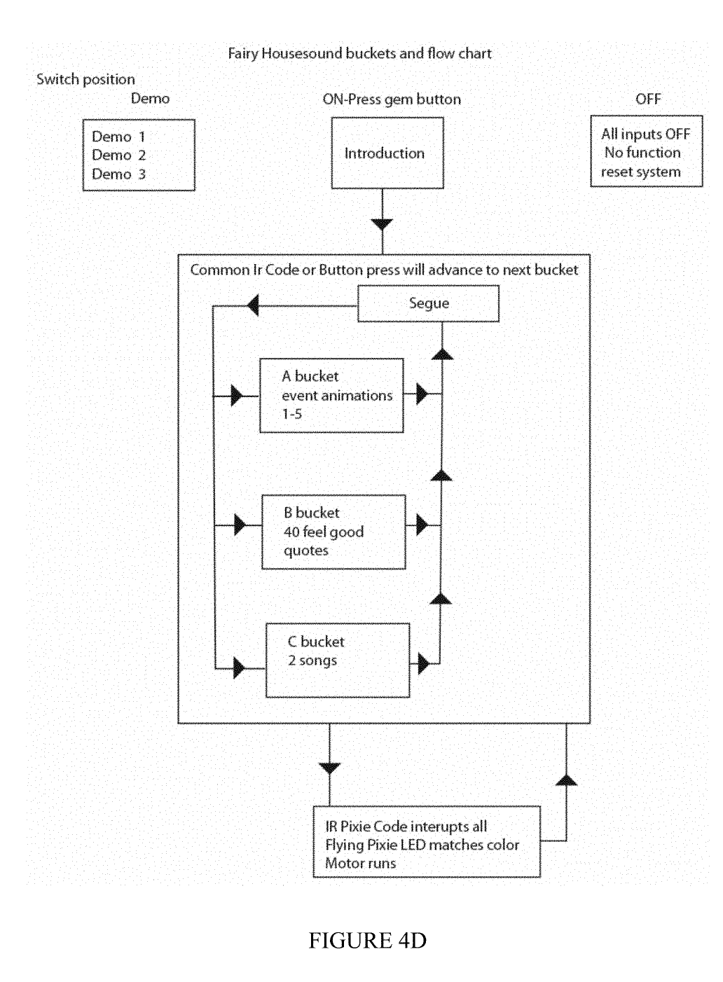

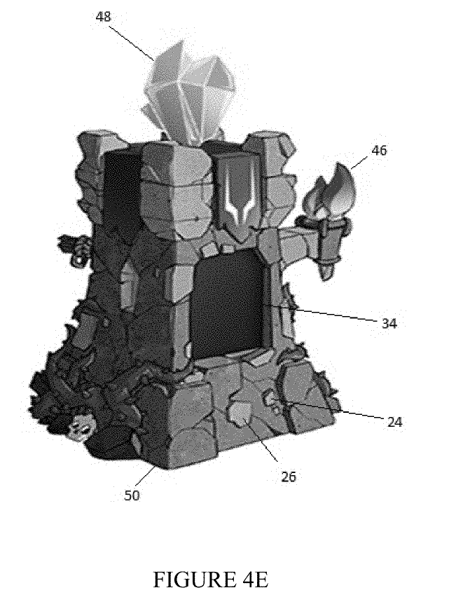

According to aspects of the present invention, and as indicated above, an exemplary wand may interact via IR signals with one or more accessories, examples of which being illustrated in FIGS. 4A-4D as a Fairy (or Pixie) House. In these examples, each accessory includes a “magic” translucent sprite 22 of a different color. Each accessory may include an IR receiver 24 to receive one or more IR signals, such as from one or more exemplary wand, wherein a particular signal may switch on one or more functions in the accessory—for example, the exemplary common or Pixie code IR signal (as illustrated above) may activate a particular exemplary accessory. In the examples shown in FIGS. 4A-4C, the user may press the “gem” push button 26 on the accessory to turn it on and/or wake it up the accessory's electronics (ICs, etc.). In some embodiments, a LED indicator may light up the gem and remain on until a user turns off the accessory using an appropriate switch/button or a period of time having elapsed without receiving IR signals via the IR receiver 24, e.g., the accessory times out. While the accessory is ON, the IR receiver 24 generally searches for wand IR signals every half second or other appropriate period of time. When a signal is detected, the accessory's electronics may play an appropriate script and then pause before searching again. If another signal is received, the accessory's electronics may play an appropriate script (which may be the same script played before, a different script, or some combination thereof), pause, and begin searching again. If no signal is detected after an appropriate period of time, e.g., three minutes, the accessory may time out or otherwise go into an Idle state. While in this state, the user may push the gem button 26 to begin/resume the IR searching.

According to aspects of the present invention, when a common IR signal is received from an exemplary wand, such as those described above, one or more of the accessory's electronics may activate one or more LEDs or lights within the exemplary house (e.g., 28, 30, 36) and play sound via a speaker 32 and/or animation via one or more LCD displays 34 from one of three or more collections/buckets of scripts, e.g., an Event bucket, a Wishing Well bucket, and a Song bucket. In some embodiments, this may be referred to as Improv mode. In this mode, the house (and its electronics) may stay in Improv mode as long as either the gem button is pushed or an IR signal from a wand is received. As noted above, if no input is detected from either the button or the IR, the house may time out and go to sleep after three minutes. Upon receiving an IR signal, e.g., Pixie Jump Spell signal from the wand, the accessory's electronics may activate the Special Pixie Code animations and light the RGB LED light(s) 28 in the roof portion of the house. In some embodiments, a motor 36 may spin a cable with one or more RGB LEDs 28 attached thereto, the accessory's electronics may light the LED 28 first in a super bright burst, and then in the matching code color, whereby the cable 38 spinning around inside the roof simulates a pixie flying around the top of the house. An exemplary flowchart demonstrating the collection of buckets and functionality is illustrated in FIG. 4D.

According to aspects of the present invention, the animation and sound scripts played by the accessory's electronics generally match the pixie code information. For example, the Pink wand sends a Pixie Jump Spell to the house, wherein the ICs in the wand play sounds via the speaker 12 and animation on the LCD displays 6 and 16 of the wand to simulate a pixie shooting up the length of the wand, and then lights one or more RGB LEDs 18 at the distal end of the wand stem, simulating the pixie/spell exiting the end of the wand. The accessory's electronics then lights up and plays an animation on one or more LCDs 34 positioned on or within the accessory structure, e.g., a “window” of the House. When the LED 28 in the roof of the house explodes with a bright white burst of light and then turns pink, the “arrival” of the pixie is thereby simulated as well. The accessory's electronics may cause the motor 36 to run for three seconds (or other appropriate period of time) spinning the Pink LED 28 around inside the roof, the animation on the LCD screens 34 and the sound script also supports the PINK pixie code information. According to aspects of the present invention, a pink pixie is shown on the LCD 34 “visiting” the house. When the accessory's electronics have completed the scripted actions/functionality, the IR sensor 24 reactivates and a new IR code may be accepted.

In this example, when the accessory's electronics detect a common IR code, the accessory's electronics may play an appropriate script, e.g., animations on the LCD screens 34 and house lights 30 and 36, but the roof LED 28 and the motor 36 remain inactivate. In some embodiments, the house may be played with or without a wand, whereby animations, lights, sounds, etc., may be activated by pressing the gem button 26 on the house (see FIGS. 4A-4C). This manual activation of the accessory's electronics may include the two RGB LEDs (e.g., 30 and 36) in the house and the single RGB LED in the roof—however, the roof LED may not move unless a Pixie Code is detected, e.g., the roof LED only activates to indicate the “arrival” of a pixie from a wand, and the moving pixie light in the roof may only be seen with the use of a wand Pixie spell.

In some embodiments, the back of the house accessory may be open much like a doll house, e.g., the rear view of FIG. 4B. A shallow play environment may be accessible with a play space for the pixie character. The set may include one or more small toy parts. Additional accessories may include, but are not limited to, table, chairs, cups, bowls, cake, pie, etc. Each set may have different accessories based on the occupant pixie's personality—for example, one Pixie likes to bake, one likes to garden, and the other one loves pets. Prior to purchase, the pixie house may be in a window box with a Try-Me push function on the gemstone switch 26, similar to the DEMO functionality described above with respect to the exemplary wands. Component parts may include, but are not limited to, a house base assembly 40, a translucent roof 42, a sprite FIG. 22, translucent lantern hanger 44, other extra accessories (demonstrated in FIG. 4B), ON/OFF/DEMO 46 (not visible in FIG. 4B, shown in FIG. 4A), a gem push button with an indicator LED light 26, LCD display 34, IR receiver 24, RGB LEDs (28, 30, 36), appropriate circuit boards (not shown), motor 36, speaker 32, sound IC (not shown), gear box assemblies (not shown), pull tab (not shown), and optional USB port (for charging batteries, updating functionality, etc.).

According to aspects of the present invention, and as indicated above, an exemplary wand may interact via IR signals with one or more accessories, another example of which is illustrated in FIG. 4E as a Wizard Tower playset. In this example, the accessory includes a a small wizard figure (not shown). Each accessory may include an IR receiver 24 to receive one or more IR signals, such as from one or more exemplary wand, wherein a particular signal may switch on one or more functions in the accessory—for example, the exemplary common or “wizard” code IR signal may activate a particular exemplary accessory. In the example shown in FIG. 4E, the user may press the “gem” push button 26 on the accessory to turn it on and/or wake it up the accessory's electronics (ICs, etc.). In some embodiments, a LED indicator may light up the gem and remain on until a user turns off the accessory using an appropriate switch/button or after a period of time has elapsed without receiving IR signals via the IR receiver 24, e.g., the accessory times out. In some embodiments, an indicator light may light one or more elements of the playset when the accessory is powered on, e.g., a translucent flame element 46. While the accessory is ON, the IR receiver 24 generally searches for wand IR signals every half second or other appropriate period of time. When a signal is detected, the accessory's electronics may play an appropriate script and then pause before searching again. If another signal is received, the accessory's electronics may play an appropriate script (which may be the same script played before, a different script, or some combination thereof), pause, and begin searching again. If no signal is detected after an appropriate period of time, e.g., three minutes, the accessory may time out or otherwise go into an Idle state. While in this state, the user may push the gem button 26 to begin/resume the IR searching.

According to aspects of the present invention, when a common IR signal is received from an exemplary wand, such as those described above, one or more of the accessory's electronics may activate one or more LEDs or lights within the exemplary tower and/or structures attached thereto, e.g., a tower gem stone 48, and play sound via a speaker (not shown) and/or animation via one or more LCD displays 34 from one or more collections/buckets of scripts, e.g., an Event bucket, a random bucket, and a shorts bucket. In some embodiments, this may be referred to as Improv mode. In this mode, the tower (and its electronics) may stay in Improv mode as long as either the gem button is pushed or an IR signal from a wand is received. As noted above, if no input is detected from either the button or the IR, the tower may time out and go to sleep after three minutes. Upon receiving an IR signal, e.g., a “Dragon's Breath Spell” signal from the wand, the accessory's electronics may activate the Special Dragon Code animations and light one or more lights (such as RGB LED lights(s)) in the gem stone 48 and/or activate a motor within the tower housing (not shown) causing the gem 48 to spin. According to aspects of the present invention, the tower's electronics may light one or more lights in the gem stone 48 in a super bright burst, and then in the matching code color. As noted above, an exemplary flowchart demonstrating the collection of buckets and functionality is illustrated in FIG. 4D.

According to aspects of the present invention, the animation and sound scripts played by the tower's electronics generally match the “dragon” code information of the wand. For example, a silver wand sends a White Dragon spell to the tower, wherein the ICs in the wand play sounds via a speaker (not shown) and animation on the LCD displays 6 and 16 of the wand to simulate a spell (or dragon, or other appropriate animation) shooting up the length of the wand, and then lights one or more lights at the distal end of the wand stem, simulating the spell/dragon exiting the end of the wand. The tower's electronics then lights up and plays an animation on one or more LCDs 34 positioned on or within the accessory structure, e.g., a “window” of the tower. When the lights within gem 48 on the roof of the tower explodes with a bright white burst of light and then turns blue/white/both, the “arrival” of the dragon is thereby simulated as well. The tower's electronics may cause the motor attached to gem 48 to run for three seconds (or other appropriate period of time) spinning the gem 48 around, the animation on the LCD screens 34 and the sound script also supports the White Dragon's Breath code information. According to aspects of the present invention, a white dragon is shown on the LCD 34 “visiting” the house. When the tower's electronics have completed the scripted actions/functionality, the IR sensor 24 reactivates and a new IR code may be accepted.

In this example, when the tower's electronics detect a common IR code, the tower's electronics may play an appropriate script, e.g., animations on the LCD screens 34 and lighting the fire structure 46, but the gem 48 and the motor remain inactivate. In some embodiments, the house may be played with or without a wand, whereby animations, lights, sounds, etc., may be activated by pressing the button 26 on the tower. This manual activation of the accessory's electronics will not cause gem 48 move unless a Dragon's Breath Spell code is detected, e.g., the gem 48 only activates to indicate the “arrival” of a dragon/spell from a wand.

In some embodiments, the tower may also have a “night light” mode. For example, this “night light” mode may be activated by a Fire Ball script or pressing and holding the gem button 26 for a period of time, e.g., three seconds. According to aspects of the present invention, scripts and animations for the night light mode may be the same for each tower, or may vary for vary for each tower.

In some embodiments, a tower's electronics may additionally enable a Battle Mode, e.g., a “battle mode” state activated by a Spider Spell. According to aspects of the present invention, this mode may not be accessible without a wand. For example, when a Spider Spell is cast on a tower, one or more spider animations may play on the wand LCDs 6 and 16, and the tower's LCD 34. After the spell animation completes, a wizard character playing on the LCD 634 may ask the wand user if they would like to battle. If a flick “yes” is registered, the wizard will tell the wand user to performed either a Lightning Bolt spell, a Ice Storm spell, or a Stone Petrify Spell (or similar list) on the count of three, e.g., the speaker 12 may play “One, two, three, Cast!”. The tower's electronics will pick one of the same three spells to cast in defense. In other words, the battle is played much like the classic game “rock-paper-scissors”. For example, Lightning Bolt beats Stone Petrify, Stone Petrify beats Ice Storm, and Ice Storm beats Lightning Bolt. An animation plays out on LCD 34 with the result of the two spells battling, such that a winner of the battle is declared. If there is a tie, the wizard animation on LCD 34 directs the wand user to cast again. The battle may continue until there is a winner and the battle ends. To battle again, the wand user would again cast a Spiders Spell.

In some embodiments, the back of the tower accessory may be open much like a doll house (not shown; similar to the rear view of FIG. 4B). A shallow play environment may be accessible with a play space for the wizard character. The set may include one or more small toy parts. Additional accessories may include, but are not limited to, table, goblin, skeleton in a cage, axe, rat, etc. Each set may have different accessories based on the occupant wizard's personality. Prior to purchase, the tower may be in a window box with a Try-Me push function on the switch 26, similar to the DEMO functionality described above with respect to the exemplary wands. Component parts may include, but are not limited to, a house base assembly 50, a gem 48, a translucent fire structure 46, other extra accessories, ON/OFF/DEMO, a gem push button 26, LCD display 34, IR receiver 24, appropriate circuit boards (not shown), motor (not shown, speaker (not shown), sound IC (not shown), gear box assemblies (not shown), pull tab (not shown), and optional USB port (for charging batteries, updating functionality, etc.).

According to aspects of the present invention, another accessory may include a Magic Tea Cup set (not illustrated in FIGURES, see Exhibit 2B) with a tea cup, small sprite figure, and boat. The tea cup may reveal a hidden face, spin on its base and play music when it receives an IR signal from an exemplary wand. Like the accessory described above, press the gem ON button on the side of the tea cup activates the accessory's electronics including an IR sensor. A small indicator light may light the gem to indicate the ON state, whereby the IR sensor begins searching for IR signals, e.g., every half-second, a search may occur. When a signal from the wand is received, the cup may light up and reveal the hidden face painted or otherwise displayed on the inside of the cup—for example, the accessory's electronics may activate an LED to illuminate the face side of the cup to highlight the face. Additionally, the accessory electronics may play a magic “bling” or sound script. If the tea cup electronics receives a subsequent IR signal, the electronics may, among other things, light up one or more LEDs, play a sound script, and cause the cup to spin on its base. For dramatic effect, the cup may rotate on a slightly non-horizontal plane and, to increase the spin, motion the top of the cup may be in a slightly-oval pattern, with the base of the cup spinning in the opposite direction. Since the base of the cup is generally round and its axis is slightly off center, the cup then appears to “dance” around the surface on which it is placed. According to aspects of the present invention, the small translucent sprite figure may plug into the leaf-boat and ride on the surface of the tea. The accessory's electronics and IR sensor may time out after three minutes (or other appropriate time). Component parts may include, but are not limited to, tea cup assembly, tea cup base, sprite figure, gem ON/OFF button, indicator LED light, IR receiver, one or more LEDs, printed circuit boards, motor, speaker, sound IC, and/or gear box assemblies.

According to aspects of the present invention, another accessory may include a dancing spoon fork and plate, with a small sprite figure (not illustrated in FIGURES, see Exhibit 2B). In some embodiments, the spoon and fork may be placed on the plate so the end of the handle of each is near a magnet ring in the base of the plate. A magnet in the end of the spoon and fork handles allows them to stand vertically on the plate when the motor is engaged and the plate magnets alien with the spoon and fork magnets. Like before, pressing the gem stone activates the accessory's electronics and an IR sensor on the side of the cake structure on the plate, whereby a small indicator light may light the gem. The unit searches for IR signals. For examples, casting a spell from the wand may cause the plate cake to light up, play music, and spin the plate magnet disk in its base. The spoon and fork may then stand up and dance on the plate. The component parts may include, but are not limited to, a spoon assembly, a fork assembly, a plate assembly, sprite figure, gem ON/OFF button, indicator LED light, IR receiver, printed circuit boards, motor, magnet plate gear assembly and spring, one or more LEDs, one or more magnets, speaker, sound IC, and gear box assemblies.

Other accessory devices may include, but are not limited to, a tea pot accessory that blows bubbles when an appropriate spell is cast by an exemplary wand and detected by the tea pot electronics, e.g., a bubble spell. Another accessory device may include a robot that dispenses candy (or other food/non-food items) when an appropriate spell is cast by an exemplary wand and detected by the robot electronics, e.g., a candy spell. Another accessory device may include a night light Gnome that lights up when an appropriate spell is cast by an exemplary wand and detected by the night light electronics, e.g., a flower spell.

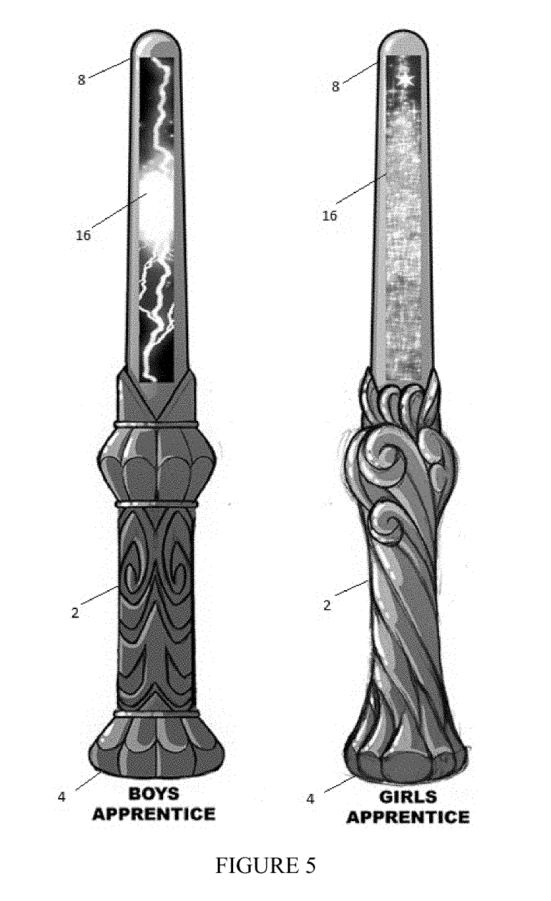

FIGS. 5A-5H illustrate one or more exemplary schematic diagrams for controlling an exemplary interactive device, e.g., wand, device accessories, or some combination thereof. One of skill in the pertinent arts will understand that other electrical components or devices may be utilized without departing from the scope of the present invention. According to aspects of the present invention, any or all of the exemplary ICs, electronics, and/or microcontrollers describe above and below may comprise one or more programmable microcontrollers, in that the microcontrollers have been programmed to perform one or more steps, instructions, set of instructions, etc., based on one or more inputs received via its PINs, a state of the microcontroller, or any other pertinent input, output, or state. Furthermore, any or all of the exemplary microcontrollers, ICs, or electronics describe above and below may be non-programmable, whereby the controller instead executes instructions stored in volatile (e.g., RAM) memory, non-volatile memory (e.g., ROM, EEPROM, storage devices, etc.), or some combination thereof. Regardless of the type of microcontroller, one of ordinary skill in the art will understand the programming required to perform the steps, functionality, etc., described above and below.

Aspects of the present invention, such as those described above, advantageously provide interactive entertainment devices, such as magic wands and related accessories. In particular, the IR-emitting and IR-detecting features of the devices and accessories enables a level of coordination between them, enabling features such the simulated travel of pixies between an exemplary wand and an exemplary accessory. It should be apparent to one of ordinary skill in the art that other devices, structures, elements, functions, and the like not described in the examples above are still within the scope of the present invention.

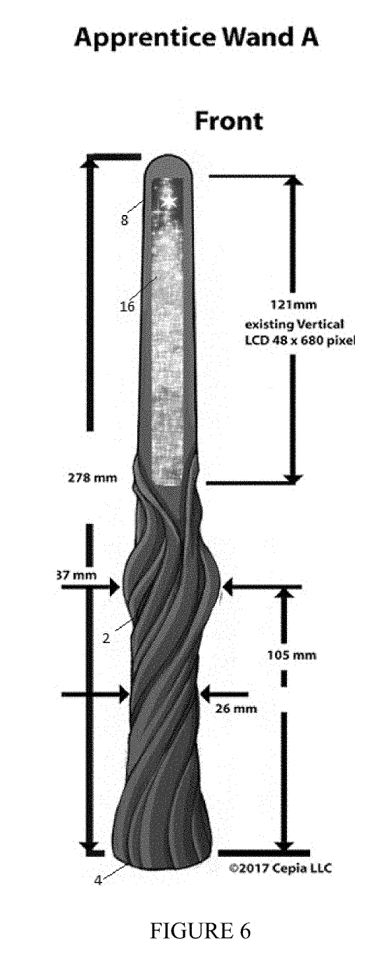

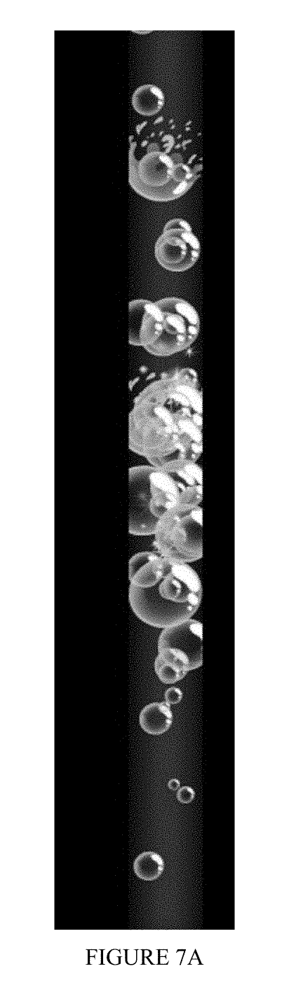

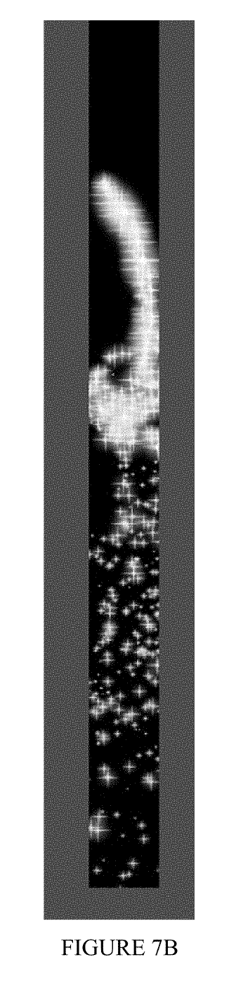

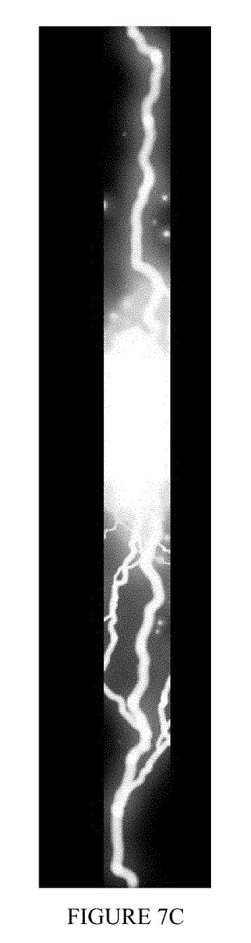

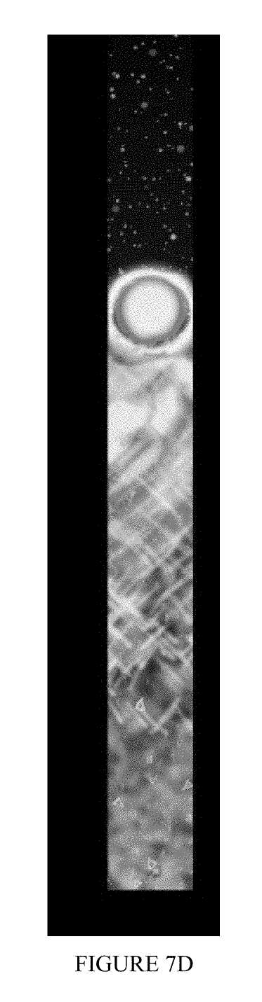

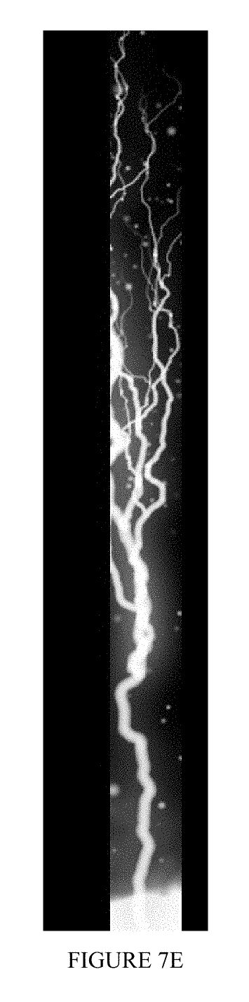

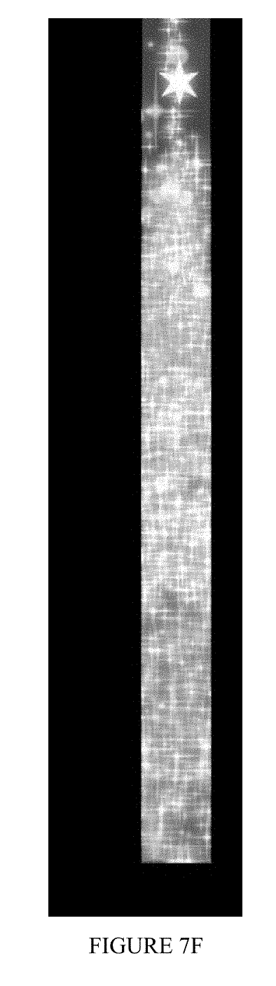

Aspects of the present invention include interactive entertainment devices such as a toy “apprentice” magic wand, examples of which are demonstrated in FIGS. 5 and 6. In these examples, various ornamental features are demonstrated that give the toy an appearance of a wand. In the examples of FIGS. 6 and 7, the handle 2 (alternately, the “base”) may include features such as spiral-shaped grooves or raised portions of the handle material, one or more “leaf'-shaped elements, or other appropriate elements, or some combination thereof. In these examples, the bottom surface of the wand 4 is flat, so that the wand may stand vertically as shown. Significantly, a cavity is contained within the wand, such as in the base or upper portion of the wand 8, or some combination thereof, within which one or more electrical/electronic elements may be placed or otherwise located for performing or otherwise effectuating the functionality described herein, e.g., powering or driving LCD displays, receiving motion or light level information, etc.

As further illustrated in FIGS. 5-6, the wand structure continues upward from the handle section 2 and extends to a generally rounded, distal end. This “wand stem” 8 may include a cavity within its structure, with this cavity generally extending from the handle section 2 towards the distal end. According to aspects of the present invention, while FIGS. 5-6 illustrate an exemplary wand that is measurably shorter than the exemplary wands showing in FIG. 1A, other wand lengths may be utilized without departing from the scope of the present invention. Furthermore, one or more elements may be placed at or near the distal end, including ornamental features such as a star-shaped feature, operative elements such as LEDs, or some combination thereof

In order to better describe the various aspects of the present invention, an exemplary toy magic wand is described herein for illustrative purposes only and should not be construed as limiting aspects of the invention. In an exemplary embodiment of the toy wand (FIGS. 5-6), an approximately 11-inch long wand is illustrated, with elements for sounds, and animations displayed on a color LCD screen. The exemplary wand may be configured with the visual characteristics, elements, features, etc., shown in FIG. 5-6, or may be configured in a similar or different manner, e.g., pixie wands, wizard wands, enchanted swords, scepters, etc. In other words, each of these is an exemplary type of interactive entertainment devices within the scope of the present invention. Generally speaking, the visual characteristics of the interactive entertainment device is indicative of the “personality” profile of the device, e.g., a “boy” apprentice wand or a “girl” apprentice wand, similar to the wands described above.

As illustrated in FIGS. 5 and 6, an exemplary wand may include one or more electronic elements, components, structures, etc., for operating or effectuating the features of the wand. For example, the wand may include one or more integrated controllers (“IC”), microcontrollers, microprocessors, or other appropriate controllers. Like above, for the sake of clarity, such controllers will be generally referred to as ICs, unless otherwise noted. An exemplary wand may additionally include one or more motion or orientation-sensitive elements, such as an accelerometer or “shake” sensor, which provides information accessible to the IC for detecting, registering, or otherwise determining movement or motion, e.g., forward/backward movement of the wand, a side-to-side movement of the wand, a shaking-type movement of the wand, other appropriate movement or orientation of the wand, or some combination thereof. An exemplary wand may further include one or more light-sensitive elements or sensors (e.g., CDS photo-cell sensor). An exemplary wand may additionally include one or more microphones for capturing auditory information for use during operation of the wand, e.g. responding to voice commands (“dance to the music”), activating functionality in response to music, etc.

The exemplary toy wand may further include, within its structure, one or more power sources for the electrical/electronic elements of the wand. For example, an exemplary power sources may include standard battery cells, proprietary battery cells, or some combination thereof. These power sources may be single-use or recharge, and may be user-replaceable or non-replaceable. According to aspects of the present invention, an exemplary wand may include an externally-oriented port for power source charging, such as a USB port. The port may optionally enable programming/instruction updates for the wand, e.g., updates to the functions/instructions implementing the functionality like that shown in FIG. 2A, adding new functionality, removing functionality, etc. The IC may signal a low battery warning and/or battery charge level via an appropriate indicator, e.g., visual elements on an LCD display or LED, sounds played over one or more speakers, etc. In some embodiments, an exemplary wand may not operate when the batteries are being charged and the LCD display may show a battery status indicator or icon. An exemplary wand may additionally include an “ON/OFF” switch, an “ON/OFF/DEMO” switch, or another appropriate switch.

The exemplary toy “apprentice” wand further includes a vertically-oriented LCD display device 16 positioned within the upper end of the wand (alternately, the “stem” 8), and may additionally include LEDs at or near the distal end of the stem. Like above, the stem 8 is comprised of a translucent or transparent material. In some embodiments, the stem includes a protective lens covering the vertically-oriented LCD display device 16. According to aspects of the present invention, the protective cover may additionally magnify, enlarge, enhance, or alter the visual image on the LCD screen 16, or some combination thereof. Again, like above, the ICs will drive the LCD display 16 in response to the information received regarding the movement or other pertinent information regarding the wand, as defined or otherwise determined by one or more instructions that makes up the wand's personality profile, e.g., animation scripts based on movement of the wand. While similar functionality is described above, the following described functionality is pertinent to the exemplary “apprentice” wands illustrated in FIGS. 5 and 6. For example, the demonstrated “apprentice” wands do not include LCD 6 like those in FIG. 1A.

According to aspects of the present invention, one of the purposes of the wand is to give the user an audiovisual experience of discovering magic or casting a spell. To do this, the wand may detect (through its various sensors) that a user has moved the wand, e.g., a quick motion such as a shaking motion, after which an audiovisual display should be provided to the user. For example, an exemplary audiovisual display should create an experience whereby the user is shown an appropriate animation displayed on the LCD 16. By utilizing imagery and animation shown on the LCD display 16 (optionally, in coordination with playing sounds effects, lighting the LEDs on the wand tip, etc.), the user is provided the experience of performing magic.

In ON mode, the process may proceed as follows:
1) ON—Magic bling sound effect.
2) Shake the wand in any direction and it sets off the animation
3) One of at least six wand animations with sound play, these appear to be random:
   a) Lightning Bolt (e.g., FIG. 7E)
   b) Electric Storm (e.g., FIG. 7C)
   c) Shooting Star (e.g., FIG. 7F)
   d) Fireball (e.g., FIG. 7D)
   e) Bubbles (e.g., FIG. 7A)
   f) Dizzy (e.g., FIG. 7B)
4) The animation plays in full without interruption and then pauses, e.g., 2 seconds,
5) When LCD 16 is not animating, LCD 16 may display a color similar to the color of the wand housing.
6) Watch for the next shake sensor input and return to step 2 above input detected.

According to aspects of the present invention, the ICs may power down (or power up) the apprentice wand after a predetermined period of time. In some embodiments, the apprentice wand may only be powered down via the ON/OFF switch. It should be apparent to one of ordinary skill in the art that other devices, structures, elements, functions, and the like not described in the examples above are still within the scope of the present invention.

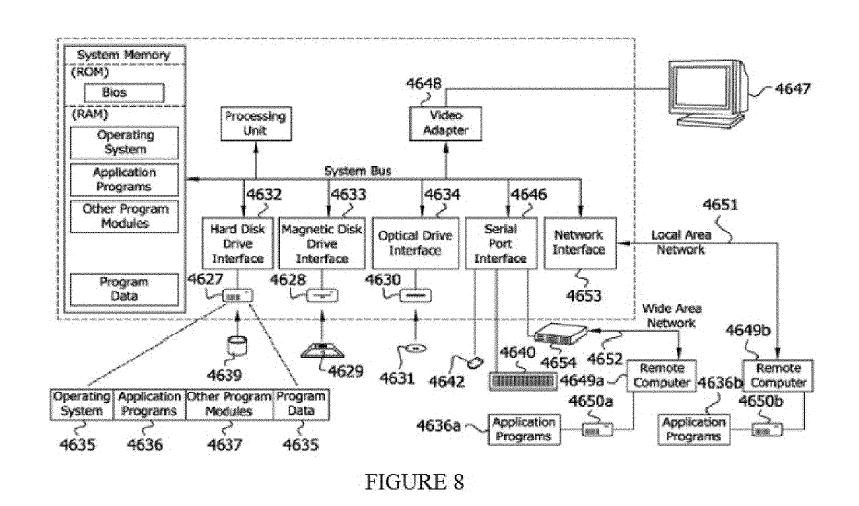

(Boilerplate “general purpose computing device” for FIG. 8 will be inserted here prior to filing—it is presently omitted due to length). One of skill in the pertinent arts will understand that other electrical components or devices described or indicated throughout may be utilized without departing from the scope of the present invention. According to aspects of the present invention, any or all of the exemplary ICs, electronics, and/or microcontrollers describe above and below may comprise one or more programmable microcontrollers, in that the microcontrollers have been programmed to perform one or more steps, instructions, set of instructions, etc., based on one or more inputs received via its PINs, a state of the microcontroller, or any other pertinent input, output, or state. Furthermore, any or all of the exemplary microcontrollers, ICs, or electronics describe above and below may be non-programmable, whereby the controller instead executes instructions stored in volatile (e.g., RAM) memory, non-volatile memory (e.g., ROM, EEPROM, storage devices, etc.), or some combination thereof. Regardless of the type of microcontroller, one of ordinary skill in the art will understand the programming required to perform the steps, functionality, etc., described above and below

Although the subject matter has been described in language specific to structural features and/or methodological acts, it is to be understood that the subject m matter defined in the appended claims is not necessarily limited to the specific features or acts described above. Rather, the specific features and acts described above are disclosed as example foi ins of implementingaspects of the invention.

What is claimed is:

1. An integrated interactive entertainment device comprising:
a wand, said wand being generally cylindrical about a first axis, said wand having a first end and a second end, said wand having a base portion extending from said first end toward the second end, configured to be held in a hand of a user, wherein a length of the base portion widens perpendicularly with respect to the first axis into a middle portion, said wand having a stem section extending from the middle portion towards the second end, wherein said base section, middle portion, and stem section each contain a cavity therein, said cavity generally extending along a length of said first axis;
one or more light sources, said light sources positioned at said second end;
a first display device, said first display device positioned at said middle portion and oriented such that said first display device is viewable by the user;
a second display device, said second display device positioned within the cavity of said stem portion;
one or more orientation devices;
one or more electronic devices, said electronic devices being operatively connected to said first display device, said second display device, said orientation devices, and said light sources, wherein said electronics are configured to selectively execute one or more instructions based on information received from said orientation devices, said instructions enabling a coordinated displaying of images on said first and second display devices and driving said light sources.

2. The integrated interactive entertainment device of claim 1, said interactive entertainment device further comprising a power source.

3. The integrated interactive entertainment device of claim 1, said light sources comprising one or more light-emitting diodes.

4. The integrated interactive entertainment device of claim 1, said interactive entertainment device further comprising at least one communication device.

5. The integrated interactive entertainment device of claim 4, said communication device comprising at least one infrared (IR) emitter, said electronic devices being operatively connected to said IR emitter, wherein said IR emitter may emit one or more signals for communicating with other structures remote from said interactive entertainment device.

6. The integrated interactive entertainment device of claim 1, wherein said information received from said orientation devices is indicative of one or more spell scripts, said spell scripts indicating one or more of said instructions.

7. The integrated interactive entertainment device of claim 1, said interactive entertainment device further comprising at least one of a light-sensitive element and a microphone.

8. The integrated interactive entertainment device of claim 1, said interactive entertainment device further comprising at least one externally-oriented port.

9. The integrated interactive entertainment device of claim 8, said externally-oriented port comprising a universal serial bus (USB) port.

10. The integrated interactive entertainment device of claim 1, said interactive entertainment device further comprising one or more computer-readable storage media, said storage media having stored thereon said instructions, said instructions being computer-executable, said instructions corresponding to one or more spell scripts.

11. An integrated interactive entertainment device comprising:
a wand, said wand being generally cylindrical about a first axis, said wand having a first end and a second end, said wand having a base portion extending from said first end toward the second end, configured to be held in a hand of a user, wherein a length of the base portion widens perpendicularly with respect to the first axis into a middle portion, said wand having a stem section extending from the middle portion towards the second end, wherein said base section, middle portion, and stem section each contain a cavity therein, said cavity generally extending along a length of said first axis;
a display device, said display device positioned within the cavity of said stem portion;
one or more motion-detection devices; and
one or more electronic devices, said electronic devices operatively connected to said display device, and said one or more motion-detection devices, wherein said electronics are configured to selectively execute one or more instructions based on information received from said one or more motion-detection devices, said instructions enabling a displaying of images on said display device.

12. The integrated interactive entertainment device of claim 11, said interactive entertainment device further comprising a power source.

13. The integrated interactive entertainment device of claim 11, said light sources comprising one or more light-emitting diodes.

14. The integrated interactive entertainment device of claim 11, said interactive entertainment device further comprising at least one communication device.

15. The integrated interactive entertainment device of claim 14, said communication device comprising at least one infrared (IR) emitter, said electronic devices being operatively connected to said IR emitter, wherein said IR emitter may emit one or more signals for communicating with other structures remote from said interactive entertainment device.

16. The integrated interactive entertainment device of claim 11, wherein said information received from said orientation devices is indicative of one or more spell scripts, said spell scripts indicating one or more of said instructions.

17. The integrated interactive entertainment device of claim 11, said interactive entertainment device further comprising at least one of a light-sensitive element and a microphone.

18. The integrated interactive entertainment device of claim 11, said interactive entertainment device further comprising at least one externally-oriented port.

19. The integrated interactive entertainment device of claim 18, said externally-oriented port comprising a universal serial bus (USB) port.

20. The integrated interactive entertainment device of claim 11, said interactive entertainment device further comprising one or more computer-readable storage media, said storage media having stored thereon said instructions, said instructions being computer-executable, said instructions corresponding to one or more spell scripts.
